(19) United States
(12) Patent Application Publication
(10) Pub. No.: US 2007/0244934 A1
(43) Pub. Date: Oct. 18, 2007

(54) Labeling system and method

(75) Inventors: Chin-Fong Pan, Taipei (TW); Wh Shih, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/395,368

(22) Filed: Mar. 30, 2006

(51) Int. Cl. G06F 17/30

(52) U.S. Cl. 707/202

(57) ABSTRACT

A labeling system and method applicable to an electronic system with a storage unit and General Purpose Input/Output (GPIO) pins is proposed. First, a setting module sets a plurality of hardware version information and combinational logics of the GPIO pins each corresponding to a different hardware version information, and stores the contents being set in the storage unit of the server system, so that the combinational logics of signals of the GPIO pins can then be read by a reading module and the corresponding hardware version information can be retrieved by a version information retrieving module, thereby allowing fast and easy determination of the current hardware version of the electronic system.

### FIELD OF THE INVENTION

The present invention relates to a labeling system and method, and more particularly, to a labeling system and method that provides hardware versions of electronic systems via GPIO pins.

### BACKGROUND OF THE INVENTION

In today's world where technology evolves with a tremendous speed, various data processing devices such as desktop computers, notebook computers, PDA, or network servers etc. are developed to bring convenience to the life and work of people, and are being widely used in various fields. Along with the development of computer and network technologies, functionalities of the data processing devices are more diverse and their hardware designs, especially for computers and servers, become more and more complicated.

When a product manufacturer is working on a hardware design of a computer or server, the design task is often divided into several parts and are handled by different hardware designers, who cooperate together to accomplish the hardware design. Functions of the designed hardware are then tested by testing personnel. During testing, problems found can be feedback to related design personnel to rework on the hardware design. These steps are repeated to complete a hardware design that passes the functional tests. Customers may also request the manufacturer to modify the hardware of the manufactured product for further improvement.

In order for the hardware personnel to track the information about the hardware, such as the version of the current hardware, the general approach is to label this information on the hardware being modified, so that the hardware designers can keep track of the hardware data based on the version number labeled on the hardware and make further modification if required. However, this conventional method of labeling the hardware with its current version number has the following drawbacks. The computer or server housing has to be opened in order to find out the hardware version, which is very inconvenient for the personnel. Further, the labels affixed to the hardware may fall out and get lost. In addition, if the label provides a plurality of versions for the personnel to select from in order to indicate the version number of the hardware, it is easy for the personnel to forget selecting such that personnel performing subsequent process cannot determine the version of the hardware.

Therefore, there is a need for a hardware version labeling technique that eliminates the abovementioned drawbacks of the prior art.

### SUMMARY OF THE INVENTION

In the light of forgoing drawbacks, an objective of the present invention is to provide a labeling system and method applicable to an electronic system to effectively label the hardware version information of the electronic system.

Another objective of the present invention is to provide a labeling system and method applicable to an electronic system that is simple and easy to be implemented without the need to open the housing of the electronic system before obtaining the label, meanwhile, avoiding the risk of losing the label or personnel forgetting to select hardware version information for the electronic system.

In accordance with the above and other objectives, the present invention provides a labeling system and method. The labeling system is applicable to an electronic system with a storage unit and a plurality of General Purpose Input/Output (GPIO) pins for labeling the electronic system with hardware version information. The labeling system comprises: a setting module for setting a plurality of hardware version information and combinational logics of signals of the GPIO pins respectively corresponding to the plurality of hardware version information and storing these settings in the storage unit of the electronic system; a signal reading module for reading the signals of the GPIO pins to obtain the combinational logic thereof and outputting the obtained combinational logic; and a version information retrieving module for receiving the combinational logic outputted by the signal reading module and retrieving the hardware version information for labeling corresponding to the combinational logic based on the settings in the storage unit.

The labeling system of the present invention performs the hardware version information labeling process during booting of the electronic system.

Additionally, the labeling system of the present invention may further comprise a displaying module for receiving and displaying the hardware version information retrieved by the version information retrieving module so as to allow users to know the current hardware version information of the electronic system according to the hardware version information displayed.

In another embodiment of the present invention, the above electronic system may further comprise a Baseboard Management Controller (BMC), wherein the version information retrieving module further comprises outputting the retrieved hardware version information to the BMC so as to allow remote users to know the hardware version information of the electronic system via a network connected to the BMC.

In another embodiment of the present invention, the hardware version information of the electronic system can be displayed on a BIOS Setup interface of the electronic system during its booting.

The labeling method of the present invention is applicable to an electronic system with a storage unit and a plurality of General Purpose Input/Output (GPIO) pins for labeling the electronic system with hardware version information. The labeling method comprises the steps of: setting a plurality of hardware version information and combinational logics of signals of the GPIO pins respectively corresponding to the plurality of hardware version information and storing these settings in the storage unit of the electronic system; reading the signals of the GPIO pins to obtain the combinational logic thereof; and retrieving the hardware version information of the electronic system for labeling corresponding to the obtained combinational logic based on the settings in the storage unit.

The labeling method of the present invention may further comprise displaying the hardware version information so as to let users know the current hardware version information of the electronic system.

Additionally, the labeling method of the present invention performs the hardware version information labeling process during booting of the electronic system.

In another embodiment of the labeling method of the present invention, the above electronic system may further comprise a Baseboard Management Controller (BMC). Correspondingly, the labeling method may further comprise outputting the retrieved hardware version information to the BMC so as to allow remote users to know the hardware version information of the electronic system via a network connected to the BMC.

In another embodiment of the labeling method of the present invention, the hardware version information of the electronic system can be displayed on a BIOS Setup interface of the electronic system during its booting.

Compared to the prior art, the labeling system and method of the present invention first allows a setting module to set a plurality of hardware version information and combinational logics of the GPIO pins each corresponding to a different hardware version information and store the contents being set in the storage unit 20 of the server system, so that the combinational logic of signals of the GPIO pins can be read by the reading module and the corresponding hardware version information can be retrieved by the version information retrieving module for indication. Thus, the present invention allows users to determine the current hardware version information of the electronic systems, and avoids the trouble of opening the housing of the electronic system before the label affixed to the hardware in the electronic system can be obtained and the risk of losing the label or personnel forgetting to select the hardware version information in the prior art.

Moreover, the present invention allows the hardware version information to be outputted to a BMC of the electronic system, so that remote users (especially hardware developers) may know the hardware version information of the electronic system via a network connected to the BMC, facilitating management of the product development.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing the basic structure of an embodiment of the labeling system of the present invention;

FIG. 2 is a schematic block diagram showing the basic structure of another embodiment of the labeling system of the present invention;

FIG. 3 shows the operational flow of an embodiment of the labeling method of the present invention; and

FIG. 4 shows the operational flow of another embodiment of the labeling method of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

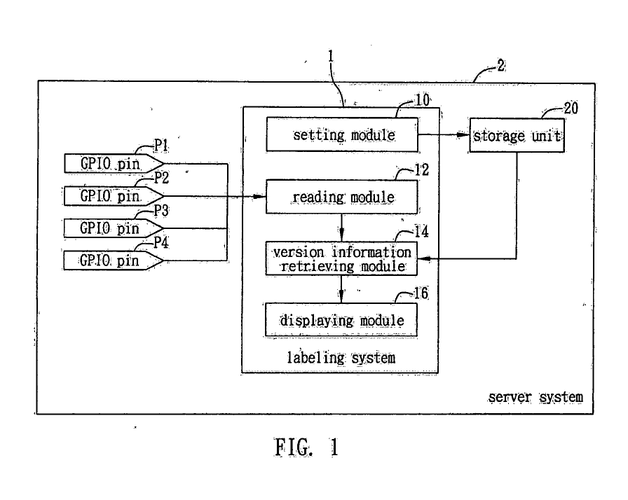

FIG. 1 is a schematic block diagram showing the basic structure of the labeling system of the present invention. As shown, the labeling system 1 of the present invention is applied to an electronic system 2 comprising a storage unit 20 and General Purpose Input/Output (GPIO) pins (P1, P2, P3, P4 . . . Pn) for labeling the hardware version of the electronic system which avoids the trouble of affixing labels and risk of losing the labels as in the prior art. In the present invention, the electronic system is for example a computer system or a server system. In order to simplify the drawings and the description, the embodiments of the present invention will be described using the server system as the electronic system, and the server system has, for example, four idle GPIO pins P1, P2, P3 and P4, but the present invention is not limited to this. In this embodiment, the GPIO pins are selected from the pins provided by a chip in the hardware architecture of the server system 2, such as the idle GPIO pins on the Southbridge or Northbridge chip. Under normal circumstances, these idle pins are floated.

As shown in FIG. 1, the labeling system 1 of this embodiment comprises: a setting module 10, a reading module 12, a version information retrieving module 14 and a displaying module 16. The setting module 10, reading module 12, version information retrieving module 14 and displaying module 16 are described in more details below.

The setting module 10 is used to set a plurality of hardware version information and combinational logics (V_{P1P2P3P4}) of the GPIO pins P1, P2, P3 and P4 each corresponding to a different hardware version information. The contents being set are stored in the storage unit 20 of the server system 2.

In this embodiment, there is a one-to-one corresponding relationship between each of the hardware version information and the combinational logics (V_{P1P2P3P4}) which is shown in the following table:

| V_{P1P2P3P4} | Hardware Version Information |
|---|---|
| 0 0 0 0 | No Rework |
| 0 0 0 1 | First Rework |
| 0 0 1 0 | 2^{nd} Rework |
| 0 0 1 1 | 3^{rd} Rework |
| . . . | . . . |
| 1 1 1 1 | 15^{th} Rework |

In this embodiment, if the values of all four GPIO pins P1, P2, P3 and P4 are zero, then the combination logic V_{P1P2P3P4} of these signals is “0000”; if the values of the four GPIO pins P1, P2, P3 and P4 are “0”, “0”, “0” and “1”, respectively, then the combination logic V_{P1P2P3P4} of these signals is “0001”; if the values of the four GPIO pins P1, P2, P3 and P4 are “0”, “0”, “1” and “0”, respectively, then the combination logic V_{P1P2P3P4}. Of these signals is “0010”; if the values of the four GPIO pins P1, P2, P3 and P4 are “0”, “0”, “1” and “1”, respectively, then the combination logic V_{P1P2P3P4} of these signals is “0011” and so forth.

Under normal circumstances, these GPIO pins are floating. When a different hardware version is produced, the present invention can program the GPIO pins to correspond to the current hardware version of the server system 2, for example, by hardware or software. The programming method is well known in this art, and will not be described further. The combination logic of the signals of these GPIO pins thus forms one of the combination logics V_{P1P2P3P4} shown in the above table, which corresponds to a unique hardware version for the server system 2. In addition, in this embodiment, the number of GPIO pins required may depend on the frequency of rework occurs in the actual hardware design process of the server system 2.

The reading module 12 is used to read the signals of the above GPIO pins P1, P2, P3 and P4 to obtain the combination logic V_{P1P2P3P4} of these signals. As shown in the above table, the combination logic V_{P1P2P3P4} obtained by the reading module is “0000”, “0001”, “0010”, “0011”, or “1111”.

The version information retrieving module 14 is used to receive the combination logic obtained by the reading module 12 and retrieve corresponding hardware version information for indication based on the settings stored in the storage unit 20 of the server system 2. For example, if the combinational logic obtained by the reading module 12 is “0010”, then the version information retrieving module 14 retrieves hardware version information of “2^{nd} Rework” based on the settings stored in the storage unit 20 of the server system 2.

The displaying module 16 is used to display the hardware version information (e.g. “2^{nd} Rework”) retrieved by the version information retrieving module 14. In this embodiment, the displaying module 16 informs users the current hardware version of the server system 2 is the third version (i.e. version after two reworks).

It should be noted that the labeling system 1 of the present invention performs the labeling process during the booting of the server system 2, for example, during a Power On Self Test (POST) procedure performed by the server system 2, so that the labeling of the hardware version of the server system 2 is performed by the labeling system 1 of this embodiment and the hardware version information is shown on, for example, a POST displaying interface. Alternatively, in another embodiment, the hardware version information of the server system 2 can also be shown on a BIOS Setup interface of the server system, so that it can be accessed by the users when entering the BIOS Setup interface instead of the POST interface that may elapse too soon to be captured by the users.

Therefore, by virtue of the labeling system 1 of this embodiment, the users are able to easily determine the current hardware version of the server system 2 during the booting process of the server system 2, avoiding the trouble of opening the housing of the server system 2 and the risk of losing the label.

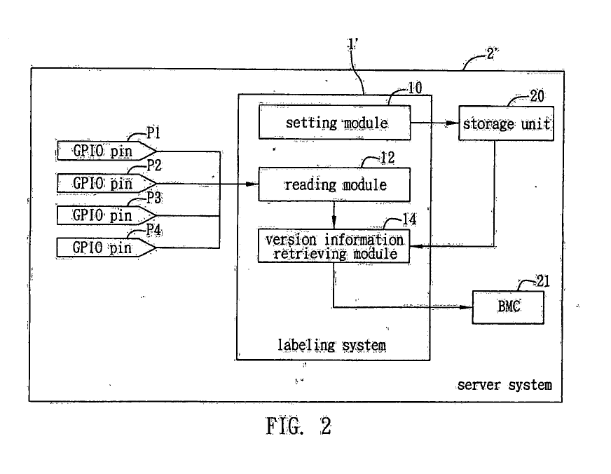

Another alternative embodiment of the labeling system of the present invention applicable to a server system 2′ is shown in FIG. 2. The difference between this and the previous embodiments is in that this embodiment does not comprise the displaying module 16 but rather a Baseboard Management Controller (BMC) 21. Since the operational relationships between the rest of the components are the same as in the previous embodiment, they will not be repeated. The labeling system 1′ of this embodiment allows the hardware version information of the server system 2′ retrieved by the version information retrieving module 14 to be outputted to the BMC 21.

As shown in FIG. 2, the version information retrieving module 14 outputs the retrieved hardware version information to the BMC 21, so that a remote user can be informed of the current hardware version information via a network (e.g. Internet or Intranet) connected to the BMC 21. Furthermore, a local user may directly access the BMC 21 of the server system 2′ to determine the hardware version information of the server system 2′.

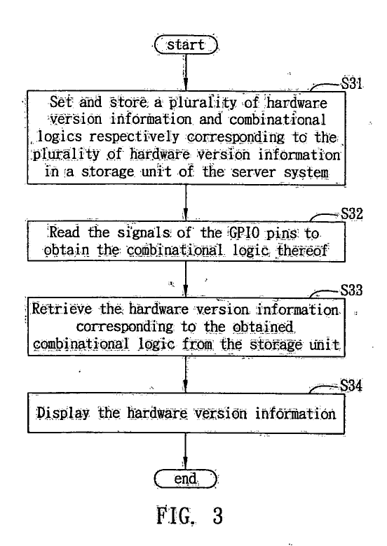

FIG. 3 shows the operational flow of a first embodiment of the labeling method of the present invention using the first embodiment of the labeling system 1 of the present invention. In step S31, allowing the setting module 10 to set a plurality of hardware version information and combinational logics (V_{P1P2P3P4}) of the GPIO pins P1, P2, P3 and P4 each corresponding to a different hardware version information and store the contents being set in the storage unit 20 of the server system 2. Next, go to step S32.

In step S32, allowing the reading module 12 to read the signals of the GPIO pins P1, P2, P3 and P4 of the server system 2 to obtain the combination logic V_{P1P2P3P4} of these signals. Next, go to step S33.

In step S33, allowing the version information retrieving module 14 to retrieve the hardware version information corresponding to the combination logic obtained by the reading module 12 based on the settings stored in the storage unit 20 of the server system 2. For example, if the combinational logic obtained by the reading module 12 is “0010”, then the version information retrieving module 14 retrieves hardware version information of “2^{nd} Rework” based on the settings stored in the storage unit 20 of the server system 2. Next, go to step S34.

In step S34, allowing the displaying module 16 to receive and display the hardware version information (e.g. “2^{nd} Rework”) retrieved by the version information retrieving module 14, such that users may know the current hardware version of the server system 2 based on the information displayed by the displaying module 16. For example, the users may know the current hardware version of the server system 2 is the third version (i.e. version after two reworks) based on the information (e.g. “2^{nd} Rework”) displayed by the displaying module 16.

It should be noted that the labeling method of the present invention performs the labeling process during the booting of the server system 2, for example, during a Power On Self Test (POST) procedure performed by the server system 2, SO that the labeling of the hardware version of the server system 2 is performed by the labeling method 1 of this embodiment and the hardware version information is shown on, for example, a POST displaying interface. Alternatively, in another embodiment, the hardware version information of the server system 2 can also be shown on a BIOS Setup interface of the server system, so that it can be accessed by the users when entering the BIOS Setup interface instead of the POST interface that may elapse too soon to be captured by the users.

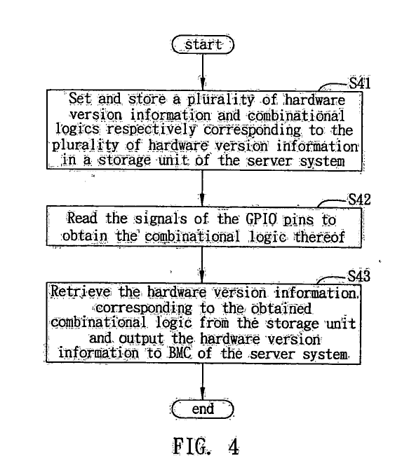

FIG. 4 shows the operational flow of a second embodiment of the labeling method of the present invention using the second embodiment of the labeling system 1′ of the present invention. In step S41, allowing the setting module 10 to set a plurality of hardware version information and combinational logics (V_{P1P2P3P4}) of the GPIO pins P1, P2, P3 and P4 each corresponding to a different hardware version information and store the contents being set in the storage unit 20 of the server system 2′. Next, go to step S42.

In step S42, allowing the reading module 12 to read the signals of the GPIO pins P1, P2, P3 and P4 of the server system 2 to obtain the combination logic V_{P1P2P3P4} of these signals. Next, go to step S43.

In step S43, allowing the version information retrieving module 14 to retrieve the hardware version information corresponding to the combination logic obtained by the reading module 12 from the storage unit 20 of the server system 2′ and output to the BMC 21 of the server system 2′. For example, if the combinational logic obtained by the reading module 12 is “0010”, then the version information retrieving module 14 retrieves hardware version information of “2^{nd} Rework” based on the settings stored in the storage unit 20 of the server system 2′ and outputs this hardware version information of “2^{nd} Rework” to the BMC 21 of the server system 2′.

Subsequently, remote users may know of the current hardware information of the server system 2′ via a network connected to the BMC 21. Furthermore, local users may directly access the BMC 21 of the server system 2′ to determine the hardware version information of the server system 2′, thus facilitating management of product development.

Therefore, the labeling system and method of the present invention first allows a setting module to set a plurality of hardware version information and combinational logics of the GPIO pins each corresponding to a different hardware version information and store the contents being set in the storage unit 20 of the server system, so that the combinational logic of signals of the GPIO pins can be read by the reading module and the corresponding hardware version information can be retrieved by the version information retrieving module for indication. Thus, the present invention allows users to determine the current hardware version information of the electronic systems, and avoids the trouble of opening the housing of the electronic system before the label affixed to the hardware in the electronic system can be obtained and the risk of losing the label or personnel forgetting to select the hardware version information in the prior art.

Moreover, the present invention allows the hardware version information to be outputted to a BMC of the electronic system, so that remote users (especially hardware developers) may know the hardware version information of the electronic system via a network connected to the BMC, facilitating management of the product development.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A labeling system applicable to an electronic system with a storage unit and a plurality of General Purpose Input/Output (GPIO) pins, for labeling the electronic system with hardware version information, the labeling system comprising:
a setting module for setting a plurality of hardware version information and combinational logics of signals of the GPIO pins respectively corresponding to the plurality of hardware version information and storing these settings in the storage unit of the electronic system;
a signal reading module for reading the signals of the GPIO pins to obtain the combinational logic thereof and outputting the obtained combinational logic; and
a version information retrieving module for receiving the combinational logic outputted by the signal reading module and retrieving the hardware version information for labeling corresponding to the combinational logic based on the settings in the storage unit.

2. The labeling system of claim 1, wherein the electronic system performs the hardware version information labeling process during booting of the electronic system.

3. The labeling system of claim 1, further comprising a displaying module for receiving and displaying the hardware version information retrieved by the version information retrieving module so as to allow users to know the current hardware version information of the electronic system according to the hardware version information displayed by the displaying module.

4. The labeling system of claim 1, wherein the electronic system further comprises a Baseboard Management Controller (BMC).

5. The labeling system of claim 4, wherein the version information retrieving module is further for outputting the retrieved hardware version information to the BMC so as to allow remote users to know the hardware version information of the electronic system via a network connected to the BMC.

6. The labeling system of claim 1, wherein the GPIO pins are provided by at least one chip disposed on the electronic system.

7. A labeling method applicable to an electronic system with a storage unit and a plurality of General Purpose Input/Output (GPIO) pins, for labeling the electronic system with hardware version information, the labeling method comprising the steps of:
setting a plurality of hardware version information and combinational logics of signals of the GPIO pins respectively corresponding to the plurality of hardware version information and storing these settings in the storage unit of the electronic system;
reading the signals of the GPIO pins to obtain the combinational logic thereof; and
retrieving the hardware version information of the electronic system for labeling corresponding to the obtained combinational logic based on the settings in the storage unit.

8. The labeling method of claim 7, wherein the electronic system performs the hardware version information labeling process during booting of the electronic system.

9. The labeling method of claim 7, further comprising displaying the hardware version information retrieved by the version information retrieving module so as to allow users to know the current hardware version information of the electronic system according to the displayed hardware version information.

10. The labeling method of claim 7, wherein the electronic system further comprises a Baseboard Management Controller (BMC).

11. The labeling method of claim 10, wherein the step of retrieving the hardware version information further comprises outputting the retrieved hardware version information to the BMC so as to allow remote users to know the hardware version information of the electronic system via a network connected to the BMC.

12. The labeling method of claim 7, wherein the GPIO pins are provided by at least one chip disposed on the electronic system.
